(19) United States
(12) Patent Application Publication
(10) Pub. No.: US 2026/0232515 A1
(43) Pub. Date: Aug. 13, 2026

(54) Adaptive Shape Changing Kinesthetic Haptic Interface

(71) Applicant: Recupero Robotics LLC, Philadelphia, PA (US)

(72) Inventor: Alwyn Johnson, Hudson, CO (US)

(21) Appl. No.: 19/432,106

(22) Filed: Dec. 23, 2025

Related U.S. Application Data
(60) Provisional application No. 63/738,513, filed on Dec. 23, 2024.

(51) Int. Cl. A61H 1/02; A61H 23/00

(52) U.S. Cl. CPC A61H 1/0288; A61H 23/00; A61H 2201/1215; A61H 2201/149; A61H 2201/1635; A61H 2201/1676; A61H 2201/5007; A61H 2201/5084

(57) ABSTRACT

Disclosed is a reconfigurable input and output system embodied in a handheld apparatus. The apparatus can apply kinesthetic stimuli and vibrational stimuli to the fingers, palm and thumb of the hand. The apparatus is capable of morphing from a specific shape or geometry into a different specific shape or geometry. Further, the disclosed methodology provides for predictable and controllable structural change using unit cell compliant bistable elements coupled with user and/or software-controlled mechanisms and actuators. The disclosed system provides a method of human computer interfacing that enables efficient implementation of intuitive control and input-output feedback with objects in a three-dimensional space. Numerous technologies may benefit from effective kinesthetic-haptic devices, ranging from controller-follower teleoperation to scaled manipulation, simulators, surgical tools, devices for the gaming industry and rehabilitation robotic devices.

This application is a non-provisional application claiming the benefits of provisional Application No. 63/738,513 filed Dec. 23, 2024, the disclosure of which is hereby incorporated by reference for all purposes.

### FIELD OF ART

The present disclosure relates generally to kinesthetic-haptic interfaces. More specifically, it relates to interfaces that have the ability to controllably and stably morph between at least two (2) shapes or sizes and provide force, displacement and vibrational feedback and input.

### BACKGROUND

The ability to handle and manipulate objects is a significant aspect of performing activities of daily living, sensory driven adjustments are essential for precision object handling. The present disclosure pertains to a therapeutic physical system, device and method for electronically mediated training and therapeutic movement and tactile input adapted for persons with impaired hand function i.e. the ability to sense and control movement of the hands and fingers.

Mechanoreceptors are a type of somatosensory receptors which relay extracellular stimulus to intracellular signal transduction through mechanically gated ion channels. The external stimuli are usually in the form of touch, pressure, stretching, sound waves, and motion. Mechanoreceptors are present in the superficial as well as the deeper layer of skin and near bone. These receptors are either encapsulated or unencapsulated, and the free nerve endings are usually unencapsulated dendrites. There are four major categories of tactile mechanoreceptors: Merkel's disks, Meissner's corpuscles, Ruffini endings, and Pacinian corpuscles. Merkel discs are slow-adapting receptors that detect continuous light touch and pressure, providing detailed information on shape and texture. Meissner's corpuscles are rapidly-adapting receptors that detect light touch, low-frequency vibration, and flutter, responding to changes in stimulus. Pacinian corpuscles are deep in the dermis for high-frequency vibration and deep pressure. Meissner's corpuscles send a strong signal when a stimulus is first applied but stop firing once the stimulus becomes constant. When the skin is touched, the movement of the corpuscle's layered discs triggers an electrical signal that is sent to the brain via an afferent nerve fiber. Ruffini endings, also known as Ruffini corpuscles or bulbous corpuscles, are encapsulated mechanoreceptors located deep within the skin (dermis and hypodermis), ligaments, and tendons. They are slowly adapting, responding to sustained stimuli, and are primarily responsible for sensing skin stretch, pressure, and joint movement. Found in the reticular dermis, hypodermis, ligaments, and joint capsules. Due to their slow adaptation, they are good at sensing non-moving or sustained pressure. They are concentrated around fingernails and in the human hand. The human hand has a high concentration of sensory receptors, predominantly in the fingertips and palms, which allows for small, well-defined receptive fields that enables rapid discernment of spatial details of objects.

Within the human hand are also Nociceptors, which are sensory nerve endings that detect potentially damaging stimuli such as pressure, in order to send “threat” signals to the brain. This initiates the sensation and potentially the memory of pain to trigger protective responses. Cells associated with most sensory receptors in the skin actively participate in the transduction of mechanical stimuli which sense mechanical pain as well as necessary for touch perception (1). The axons or long, slender extensions of nerve cells associated with nociceptors conduct i.e. convey information between 2 to 20 m/s. Peripheral nervous system (PNS) somatosensory receptors provides a means of neural feedback that allows the central nervous system (CNS) to detect, receive, process, and integrate sensory information to coordinate conscious thought, emotions, movement, and memory for automatic processes like heartbeats and breathing. Effective and compact mechanical systems that simulate multiple modalities of vibration and movement sensory input to the fingers have the potential to provide a pathway for rehabilitation and training. There are several efforts to provide compact and low-priced movement transmission assembly components in kinesthetic-haptic devices. These technologies have the potential to provide resistance or movement to a user for rehabilitation and allow users to feel realistic size, shape and movement during the manipulation of a virtual object in a digital environment.

To enable dexterous manipulation, receptors in the fingers and hand provide tactile information to the motor control system, and sensory nerve fibers that innervate these receptors (tactile afferents) encode mechanical parameters for manipulation of held objects. U.S. Pat. No. 11,205,329B2 discloses a device that utilizes the combination of a discrete array of tactors that produce normal forces to the skin in a sequential pattern and a discrete array of tactors that produce lateral forces to the skin in a sequential pattern. The invention results in perceived motion of a contact point across the skin. In contrast, the combination of kinesthetic-haptic apparatus in the present disclosure can be utilized to stimulate the peripheral nervous system to innervate receptors to perceive augmented feedback such as manipulating an object which is orders of magnitude smaller or larger than the human hand. Finger displacement, forces and vibration can be selectively output to modify the perception of the cover apparatus and/or object interactions in teleoperation or virtual environments. The disclosed device provides the capability to produce kinesthetic haptic illusions. This presents a method that can be used to train a user how to perform tasks in structured and unstructured environments. Data representing force, vibration, pressures and position can be saved, replayed, modified and communicated to users. This aspect can be directed to the capability of the interface to operate and provide movement to a manipulator. The apparatus has the capability to communicate representations of letters, numbers, and symbols through mechanical cues utilizing movement mechanisms and vibratory stimuli. The device thus has the capability to alter or modify crucial components of the sensory feedback loop required for stable, functional, and coordinated finger movement and perception. This apparatus provides an inexpensive technology that can be fabricated using traditional and/or additive manufacturing technologies. Components can be ergonomically sized and tailored to suit a large number of users or easily custom designed and fabricated to suit a single individual.

As disclosed herein, the system provides the capability to selectively and simultaneously input multiple frequency and amplitude vibratory stimulus to the fingers and palm of the hand. The system provides the capability to provide high and low frequency movement or kinesthetic stimulus to the fingers and palm. This system apparatus and method allow for physically altering the three-dimensional shape of a surface and, for providing modular force and vibration outputs. The surface geometry of the apparatus is reconfigurable based on a variety of considerations (including application, mode, and/or user needs, etc.) This provides the capability to preprogram multiple shape structures into a library based on a given embodiment. Integrated within the exterior surface of the apparatus is a plurality of unit cell compliant bistable (having two stable states) elements, and particular arrangements thereof, that can transform or morph a structure from one shape to another. A compliant mechanism is a flexible mechanism that transfers an input force or displacement to the deflection of flexible segments thereby replacing the need for mechanical joints. A compliant bistable mechanism achieves stability within the designed range of motion, by storing and releasing strain energy in its relatively compliant segments [3]. In compliant mechanisms elastic deflection can be engineered to produce desired movement of nodes or segments. These mechanisms can maintain two energetically/geometrically stable positions or equilibrium states where they can remain position or geometry without the need for an external power/force. Compliant bistable mechanisms provide an effective method to achieve two mechanical/geometric stable configurations in single component. A surface can be defined as the outside or uppermost layer of an object in contact its environment. A method for having a surface shape and the corresponding surface geometry that may be modified or adjusted without damaging the surface, maintains rigidity in response to a range of normal forces and that has stability in multiple positions or shapes has many applications. As such, compliant bistable structures with localized compliance can be designed as monolithic components. The stiffnesses of the compliant bistable structure elements can be maintained by an internal mechanism that applies stabilizing forces to the elements. Developing structure apparatus comprised of bistable elements that have the capability to predictably and repeatably respond to multiple loading patterns with predetermined deflection and displacement modes is an ongoing engineering design challenge in many technologies.

### SUMMARY OF THE DISCLOSURE

An aspect of the disclosed system is to provide a handheld controller with a wireless communication device within its housing that is connected to at least one processor or input-output control system.

Another aspect of the disclosed system is to provide a device that can be selectively configured and/or adjusted in a number of ways to facilitate hand-specific modules for different users with varying hand sizes while engaged in varying computing activities.

An aspect of the disclosed system is to provide for kinesthetic feedback, such as active and resistive force output and/or haptic feedback such as tactile sensations of vibration, texture, and heat to a user.

Another aspect of the disclosed system is to provide users with force-feedback information on the motion and/or force that they generate.

An aspect of the disclosed system is to provide a mechanism that can be utilized provide users training and/or therapy for independent natural finger movement and restore their ability to perform activities that require the full dexterity of their hands.

Yet another aspect of the disclosed system is to provide the ability to vary the input and reactive forces and displacements to fingers on the holder's hands, provides the holder the capability to manipulate the apparatus in a myriad of ways.

Another aspect of Applicant's system is to provide a mechanism that can receive multiple types of input including touch sensed input.

Another aspect of Applicant's system is to provide a device having internal linkage mechanisms and wherein the cover apparatus can integrate one or more sensors, accelerometers, speakers, vibrational motors and control buttons.

Another aspect of Applicant's system is to provide a device having one or more compliant bistable structure elements that form a cover or enclosure or assembly about an internal apparatus or mechanism with a plurality of repositionable linkages and movable elements.

Another aspect of Applicant's system is to provide a cover apparatus having linkages and movable elements to provide vibrational input, displacement, and input-output forces thereto.

Yet another aspect of Applicant's system is to provide the capability to change the interface geometry and position of sensors, buttons and keys integrated within the apparatus.

An aspect of Applicant's system is to minimize space requirements by enabling inputs based on position on a smaller device to replace a static physical keys and buttons.

An aspect of the disclosed system is to provide an interface device having of a plurality of buttons and sensors connected to linkage sub-assemblies that can be used as a controller to enable precise finger manipulation, such as rotation, rolling, or twisting of the grip.

An aspect of the disclosed system is to utilize accelerometers to detect the orientation of the device relative to each of the fingers and the palm.

An aspect of the disclosed system is to provide cues for predefined movements and hand postures.

Another aspect of the disclosed system is to use vibration effects, or vibrotactile haptic effects, to provide cues to users of electronic devices to alert the user to specific events

Another aspect of the disclosed system is to use vibration effects, or vibrotactile haptic effects, to provide realistic feedback to create greater sensory immersion within a simulated or virtual environment.

Another aspect of the disclosed system is to use visual and/or audio cues to remind and guide user gestures.

An aspect of the disclosed device is to provide a user interface device that transmits movements which can provide command signals for control and manipulation of robotic end-effectors actuator of with varying levels of dexterity.

Another aspect of Applicant's device is it can adapt to a specific user.

An aspect of Applicant's device is it can adapt to provide a computer programmable or user requested shape configuration, and provide an applied or responsive force on the fingers of the hand.

Yet another aspect of Applicant's device is to stimulate the peripheral nervous system to innervate receptors to perceive augmented feedback such as manipulating an object which is orders of magnitude smaller or larger than the human hand.

Another aspect of Applicant's device is to selectively output finger displacement, forces and vibration to modify the perception of the cover apparatus and/or object interactions in a teleoperation or virtual environments.

Another aspect of Applicant's device is to provide the capability to produce kinesthetic haptic illusions.

An aspect of Applicant's device is to provide method that can be used to train a user how to perform tasks in structured and unstructured environments.

Another aspect of Applicant's device is to communicate representations of letters, numbers, and symbols through mechanical cues utilizing movement mechanisms and vibratory stimuli.

Another aspect of Applicant's device is to alter or modify crucial components of the sensory feedback loop required for stable, functional, and coordinated finger movement and perception.

These and other advantages of the disclosed device will appear from the following description and/or appended claims, reference being made to any accompanying drawings that form a part of this specification. It is to be understood that the disclosed method and apparatus are not limited in application to the details of the particular arrangements shown; the disclosed method and apparatus each capable of other embodiments. Also, the terminology used herein is for the purpose of description and not of limitation.

### BRIEF DESCRIPTION OF THE DRAWINGS

FIG. 1A, and 1B show an exemplary embodiment of the disclosed device.

FIG. 2A, and 2B show exemplary embodiment of the disclosed device.

FIG. 3 shows an exploded view of the central drive mechanism having a sliding joint that moves a user's fingers away from the palm.

FIGS. 3A and 3B show the secondary connecting rod of one embodiment of the disclosed device.

FIG. 4 depicts two halves of a central handle which encases the central drive mechanism.

FIG. 5 depicts an alternate view of the two halves shown in FIG. 4.

FIG. 6 is an exploded view of the slider crank-lead screw subassembly that moves a user's thumb away from the palm.

FIGS. 7A-7D illustrate the possible finger positions corresponding with various positions of the magnus and clavicular keys.

FIGS. 8A-8C illustrate various views of the compliant thumb lock.

FIGS. 9A-9E illustrate the possible thumb and finger positions corresponding with various positions of the magnus and clavicular keys.

FIGS. 10A-10D illustrate the possible thumb and finger positions corresponding with various positions of the bistable lock of the disclosed device.

FIGS. 11A, 11B and 11D depict an embodiment of the device having three ball joints.

FIG. 11C shows the disclosed device having an optional strap and a smart watch for data collection and management.

FIG. 12 shows an exploded view of another embodiment of the central drive mechanism having a plurality of vibration motors and sensors.

FIGS. 13A-13E illustrate a modification of the ball and socket of the disclosed device.

FIG. 14A illustrates an exploded view of the internal drive mechanisms of the disclosed device.

FIG. 14B depicts the internal drive mechanism and grip in a user's hand.

FIGS. 15A, 15B depict an embodiment of the bistable finger lock array.

FIG. 16 illustrates a cutaway of the cover apparatus encasing a cylindrical shape.

FIG. 17 illustrates a cutaway of the cover apparatus encasing a spherical shape.

FIG. 18 depicts various hand movements and positions involved with the disclosed device.

FIG. 19 provides for anatomical references for the hand.

### DESCRIPTION

The following description is provided to enable any person skilled in the art to make and use the disclosed system and method. Various modifications, however, will remain readily apparent to those skilled in the art, since the generic principles of the present apparatus have been defined herein specifically to provide for a system, device and method for an electronically mediated therapeutic exercise adapted for persons with impaired hand function i.e. the ability to sense and control movement of the hands and fingers.

The apparatus disclosed herein is designed to provide kinesthetic feedback, such as active and resistive force output and/or haptic feedback such as tactile sensations of vibration, texture, and heat to a user. Haptic devices provide users with force-feedback information on the motion and/or force that they generate. In the field of rehabilitation robotics, the disclosed device can be utilized provide users training and/or therapy for independent natural finger movement and restore their ability to perform activities that require the full dexterity of their hands. Varying the input and reactive forces and displacements to fingers on the holder's hands, provides the holder the capability to manipulate the apparatus in a myriad of ways.

Multiple types of input can be received including receiving touch sensed input. The internal linkage mechanisms and the cover apparatus integrate a plurality of sensors (including force, temperature and accelerometers etc.), compact speakers, ultrasound/parametric speakers, vibrational motors and control buttons. This disclosed device relates to a plurality of compliant bistable structure elements that form a cover or enclosure apparatus or assembly about an internal apparatus or mechanism with a plurality of repositionable linkages and movable elements. The linkages and movable elements are designed to provide vibrational input, displacement, and input-output forces to elements of the cover apparatus. The capability to change the interface geometry and position of sensors, buttons and keys integrated within the apparatus provides the ability to provide inputs based on position on a smaller device in order to replace a large number of different static physical keys and buttons that take up a lot of space.

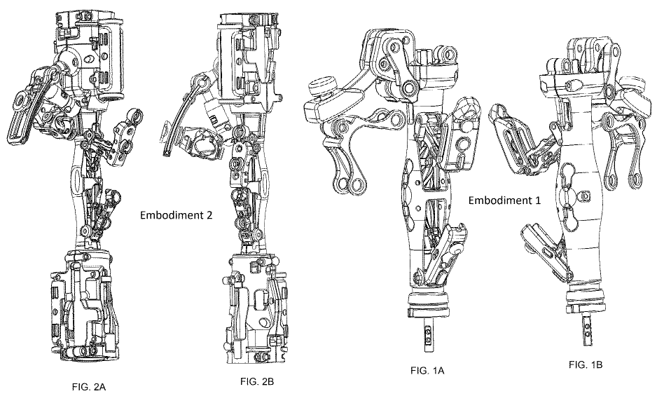

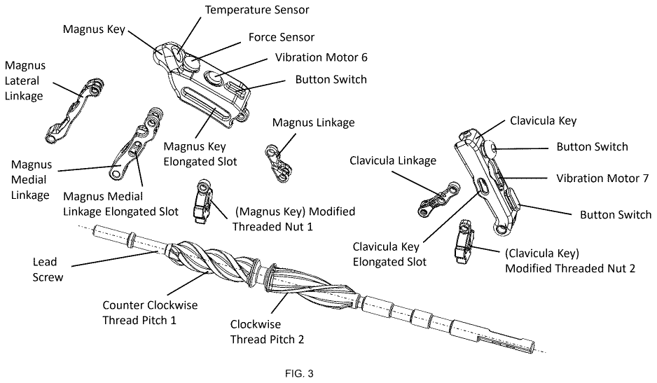

As shown in FIGS. 1A, 1B, 2A, 2B, the interface device is comprised of a plurality of buttons, sensors, and the connected to the linkage sub-assemblies of the interface that can be used as a controller with the capacity for precise finger manipulation, such as rotation, rolling, or twisting of the grip. Accelerometers can be utilized to detect the orientation of the device relative to each of the fingers and the palm. The device may also be used to provide cues for predefined movements and hand postures. In one embodiment, vibration, force, displacement and temperature can be modified to provide cueing. Specifically, vibration effects, or vibrotactile haptic effects, may be useful in providing cues to users of electronic devices to alert the user to specific events, or provide realistic feedback to create greater sensory immersion within a simulated or virtual environment. The device may also be used with visual and/or audio cues to remind and guide user gestures. An aspect of the present disclosure is a user interface device for transmitting movements which can provide command signals for control and manipulation of robotic end-effectors actuator of with varying levels of dexterity. This relates to the use of this disclosed device as a handheld controller with a wireless communication device within said housing connected to at least one processor or input-output control system. The apparatus that can be selectively configured and/or adjusted in a number of ways to facilitate hand-specific modules for different users with varying hand sizes while engaged in varying computing activities.

In one embodiment, a surface reconfiguration system includes the cover apparatus or flexible surface; internal linkages forming a reconfigurable support frame are connected to the cover apparatus to create alterations in the contours of the cover apparatus surface assembly and a control component that controls the adjustments to the linkages. Integrated within the support frame assembly are a plurality of locking members. Thus, the surface is configurable based on application, mode and/or user needs. The cover apparatus can be used to provide input and output functionality. The cover apparatus surface can include touch detection functionality for added input functionality.

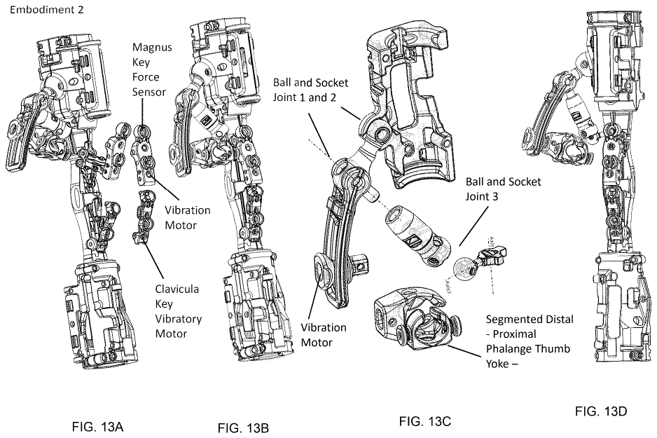

In one embodiment a surface reconfiguration system comprised of a plurality of compliant bistable elements is attached to the internal kinesthetic-haptic mechanism that can selectively vary position of elements and overall shape of the enclosure. The flexible surface enclosure and actuation sensing component interact to provide both input and output to a user of the system. In one embodiment the motors rotate the central drive which translates from a stable cylindrical 3D geometry to a spherical geometry with finger placement along the interface, replicating a power or cylindrical grip of the user to a spherical grip posture. See FIG. 12.

In certain embodiments, the current device provides a method/ability to transform a structure from one specific shape to another using the combination of bistable elements, four bar mechanisms and linkage mechanism with a minimum of one internal motor drive. In one embodiment the threaded sections are clockwise and counter clockwise and the corresponding nuts move away from each other increasing distance along the central threaded drive. The nuts are connected to a minimum of one link that has a hinge with an axis located a radial plane perpendicular to the long axis of the threaded drive shaft.

In one embodiment, three (3) bi-stable latching sub-assemblies are devised to securely connect to the thumb, the index and middle fingers, the ring and small fingers to the device. The bistable latching mechanism can connect and hold fingers to maintain contact with the interface. The bistable interlocking elements may be used to reduce the cognitive and physical activity required to maintain grasp forces by a user. This and similar embodiments may also be used to assist a user with reduced grip strength and/or impairment to securely and stable interlock with the device. Additional embodiments have five linkages that connect to each finger and the thumb.

In one embodiment two servomotor actuators drive two coaxial lead screw mechanisms. Each lead screw mechanism converts rotation on the motor axis to linear motion of a threaded nut. The actuator that drives the screw mechanism can have a self-locking function that maintains position while the motor power is off. A plurality of linkages are connected to the threaded nuts of the lead screw mechanism.

The disclosure is directed to a device for transmitting movements, comprising a four-bar mechanics structure adapted to provide movement radially and on the long axis of the interface. An extension mechanism that uses four-bar mechanics found a in a natural knee. A central drive mechanism is connected via radial links that flex and extend radially from the long axis of the internal drive shaft. The drive shaft is comprised of a lead screw mechanism with a plurality of modified threaded nuts. The lead screw has threaded sections that have a minimum of one pitch or distance between adjacent threads, with multiple threaded lengths. Each pitch corresponds to the rate at which the nut moves along the axis of the lead screw. The thread pitch(s) and lengths of the threads are devised to correlate to the radial movement of the linkages relative to the central axis of the lead screw. Thus, a single rotation of the lead screw can axially displace corresponding nuts at varying rates. The relative rate of flexion-extension of Index and Middle finger relative to Ring and Small fingers is determined by the multiple pitch threads. This allows for the use of a single motor to conform flexion-extension profiles for users.

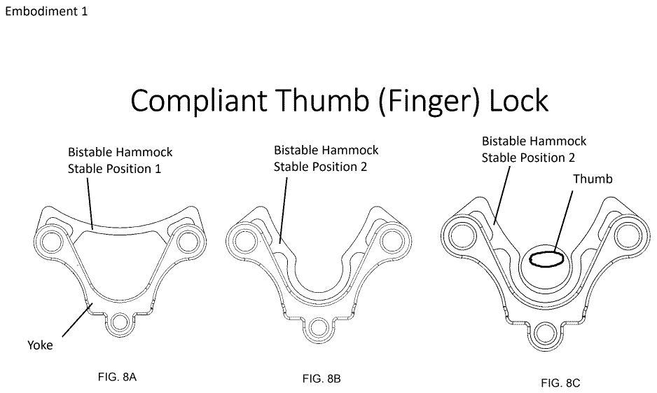

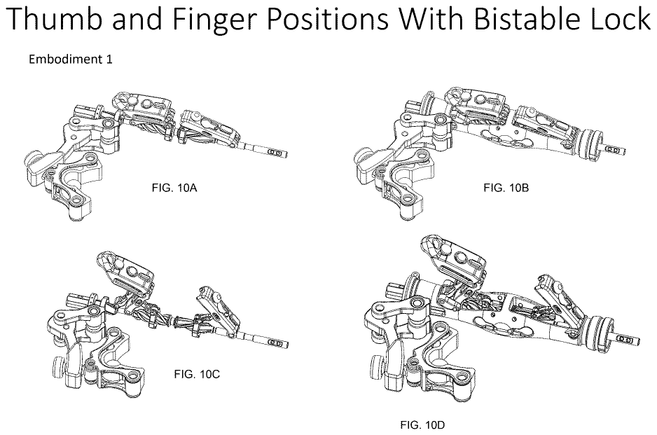

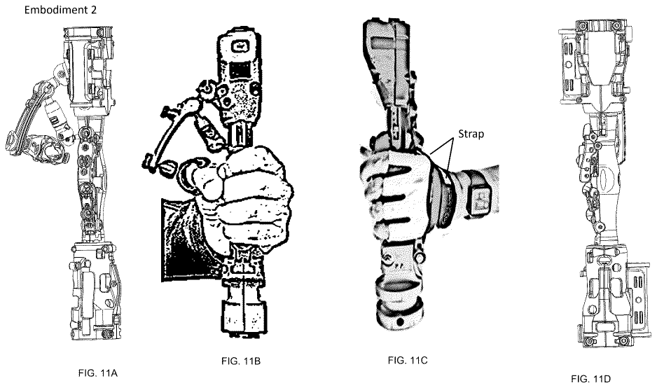

In one embodiment a four-bar linkage sub-assembly and a planar joint sub-assembly are each connected to a single lead screw mechanism. See FIGS. FIGS. 7A-7D. See also FIGS. 10A-10D The two sub-assembles are housed within and are connected to an ergonomically designed hand grip that is placed in direct contact with the transverse axis and palmar arch of the hand. The planar joint sub-assembly is comprised of a clavicula key or linkage with an internal elongated slot, a modified lead screw nut, and a modified lead screw nut linkage, a pivot joint and a sliding pivot joint. A pivot joint connects the clavicula key to the hand grip via a pivot joint proximal to the small finger. An internal elongated slot in the RSF linkage with a sliding pivot joint connects the small key to a modified lead screw nut linkage. This end of the modified lead screw nut linkage slides along the elongated slot when the nut moves along the axis of the lead screw. The modified lead screw nut linkage is connected to modified lead screw via a pivot joint. As the modified threaded nut moves along the long axis of the lead screw the linkage displaces the clavicula key rotating it about the axis of the pivot connection on the hand grip. This motion can be towards or away from the lead screw axis depending on the direction of rotation of the lead screw. The small and ring fingers are coupled to this sub-assembly which is devised to displace these fingers, effectively flexing or extending the fingers. See FIGS. 9A-9E.

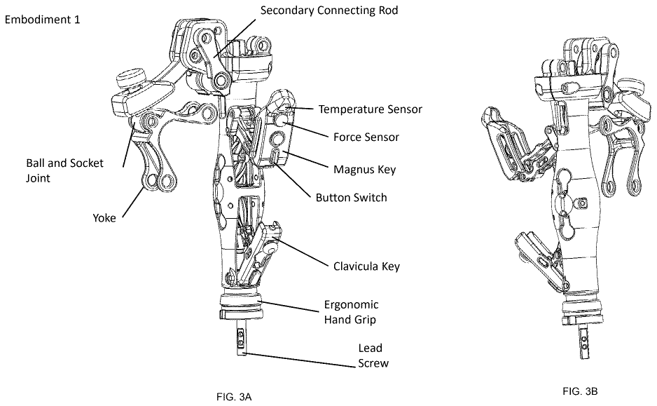

FIG. 3 shows an exploded view of the central drive mechanism having a sliding joint that moves a user's fingers away from the palm.

The four-bar mechanism sub-assembly is comprised of a lateral linkage, a medial linkage with an elongated slot, a magnus key, a modified lead screw nut and a modified lead screw nut linkage. The lateral linkage and a medial linkage with an elongated slot are connected to the hand grip via two (2) pivot joints on one end. On the other ends the linkages are connected to a magnus key or linkage with an internal elongated slot. The lateral linkage is connected to the large key via a sliding pivot joint which slides along the elongated slot. The medial linkage is connected to the magnus key via a pivot joint. The elongated slot of the medial linkage is connected via a sliding pivot joint to a modified lead screw nut linkage. The modified lead screw nut linkage is connected to the modified lead screw via a pivot joint. As the modified lead screw nut moves axially on the lead screw this displaces the lateral and medial linkages, with corresponding displacement to the magnus key. The overall displacement and extension of this sub-assembly is devised based on four-bar mechanics found in a natural knee. The index and middle fingers are coupled to this sub-assembly which is devised to displace these fingers, effectively flexing or extending the fingers.

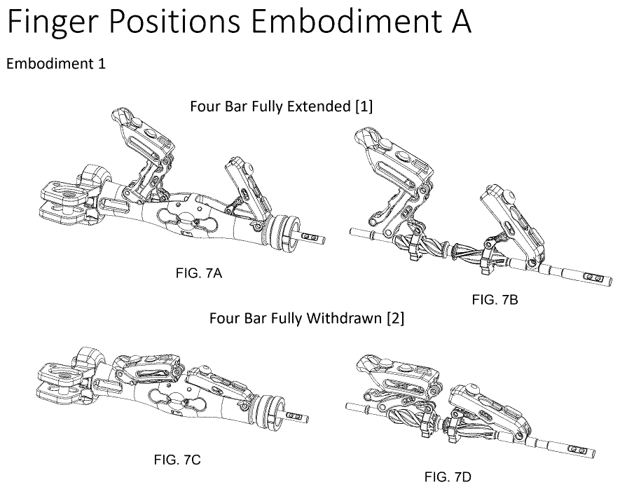

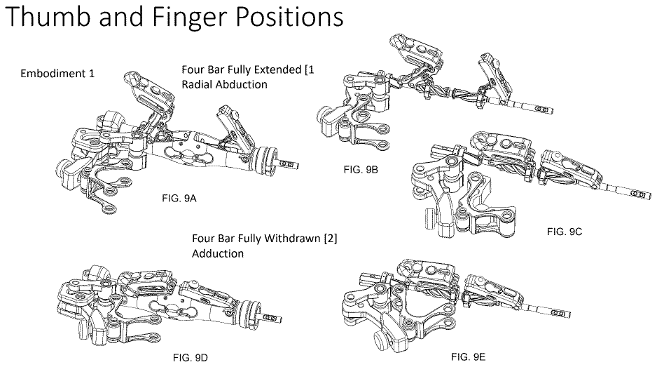

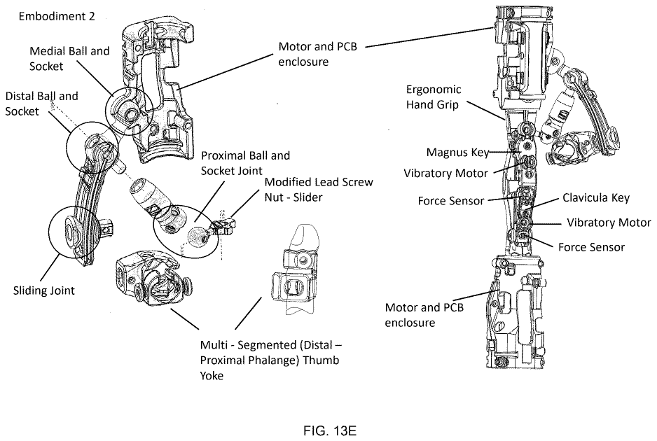

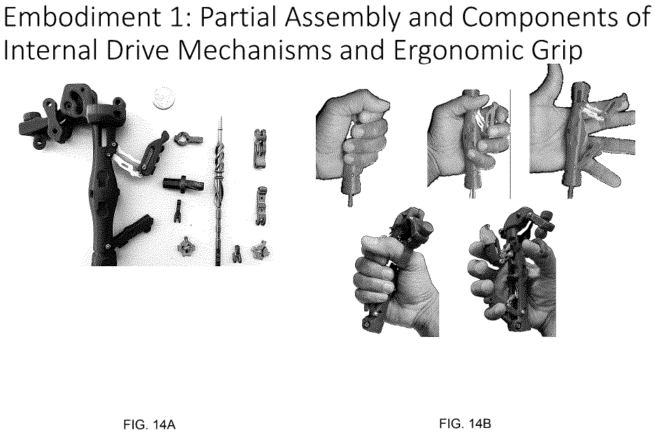

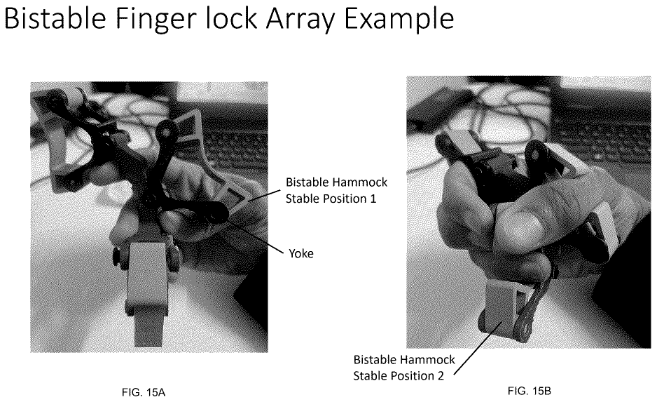

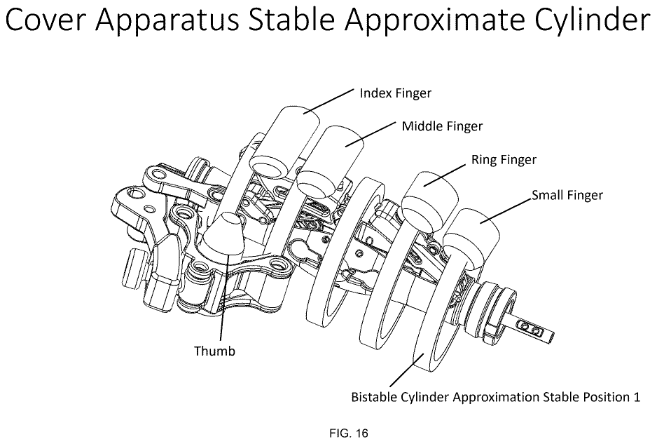

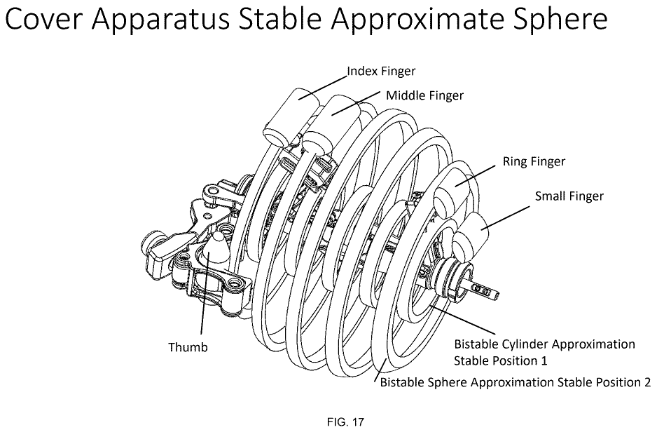

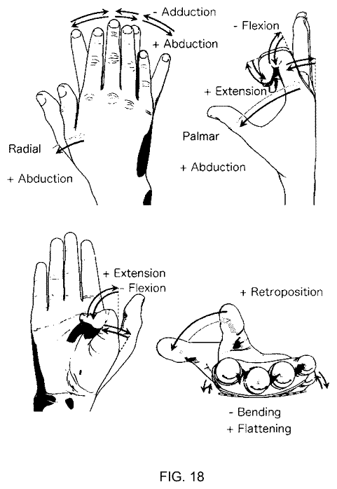

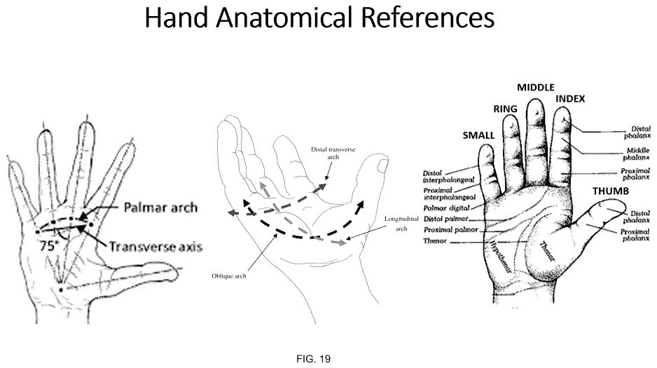

In one embodiment a thumb adduction and abduction mechanism is comprised of a lead screw mechanism and slider crank mechanism. See FIG. 6. The thumb can be adducted; where the adducted position provides the user with the capability to apply forces parallel to the palm along the side of the fingers. The thumb can be abducted; where the abducted position provides the user with the capability to apply forces to oppose the finger tips. The lead screw mechanism is adjacent to the lead screw subassembly that displaces the four fingers. The threaded nut on the lead screw is used as a slider component on the slider-crank mechanism. A secondary connecting rod couples the crank on the crank mechanism to the thumb. See FIG. 3. The movement of the slider crank mechanism rotates the thumb towards or away from the axis of the lead screw. The secondary connecting rod integrates a ball and socket joint at the end proximal to the thumb. The ball and socket joint integrate a compliant locking mechanism ergonomically sized to grasp and stably connect to thumbs of multiple size users. In this embodiment a single motor is connected to each of the lead screws to drive the movement of the thumb and the fingers independently. See FIGS. 8A-8C. See also FIGS. 13A-13E. The computer-controlled motors can be programmed to move the modified nuts and corresponding couplings and linkages to displace and apply forces to the cover assembly apparatus to form multiple geometries.

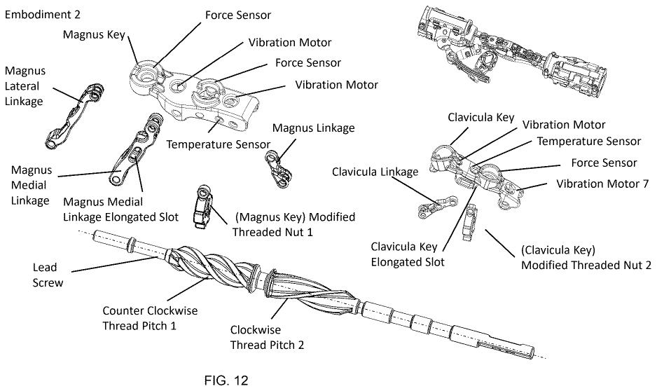

In one embodiment a thumb abduction/adduction sub-assembly that utilizes two ball joint couplings, and a sliding joint to move the thumb along trajectories away from the palm. See FIGS. 11A, 11B and 11D.

In one embodiment, force sensors, accelerometers, gyroscopes and hall effect sensors integrated within the printed circuit boards, in addition to control methods of the motors, can be utilized to measure finger forces, orientation of the palm, movement and position of each finger and thumb.

The internal mechanism can displace the exterior apparatus to one of the stable positions may be a disk configuration, and to another stable position that may be a hemisphere configuration. The stable radial elements in this instance would be displaced to a second stable position where the previously the radial nodes comprising the surface of the disk would bend and not stretch to become the longitude lines on a stable position hemisphere. Additionally, the distance between circumferential nodes on the disk decrease to move to stable positions representing latitude lines on the hemisphere.

In another embodiment a plurality of slider crank, lead screw, and four bar links can be located along the length of the handle grip. The elements of each mechanism can be utilized displace or provide forces to the fingers and/or the cover apparatus.

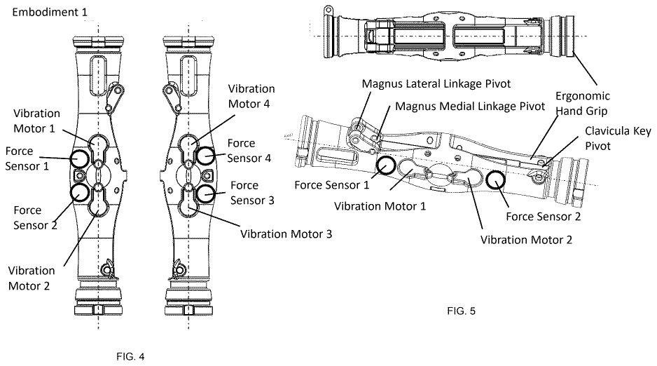

FIG. 4 depicts two halves of a central handle which encases the central drive mechanism.

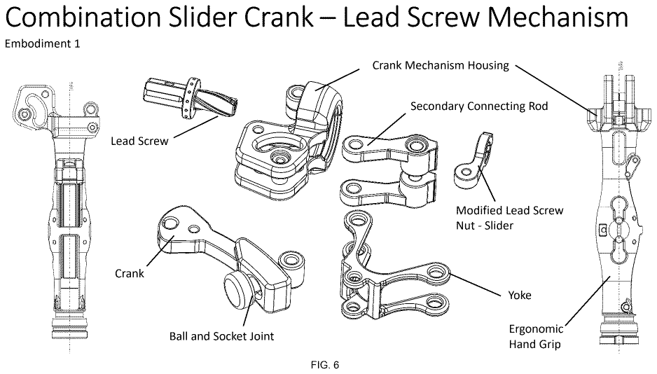

FIG. 5 depicts an alternate view of the two halves shown in FIG. 4.

In another embodiment the cover apparatus can be removed from the internal drive mechanisms. The compliant locking mechanisms can be used to connect the fingers. The drive mechanisms can be used to displace and apply forces to the coordinated positioning of the fingers through multiple sequences.

In one embodiment of the device a plurality of force resistive sensors located at the center of the hand, along the distal transverse arch of the palm corresponding to the metacarpophalangeal joints and, along the magnus and clavicle keys corresponding to each finger provides the ability to measure the normal forces applied to the

In one embodiment a micro magnetic clutch system integrated within the housing can be used to provide movement to the linkages at multiple speeds and frequencies.

The device provides the ability to measure the normal force applied at the palmar contact corresponding to the metacarpophalangeal joints and along the magnus and clavicle keys corresponding to each digit.

Using computer control methods diagnosed impairment of hand function can be targeted for therapeutic intervention through induced movement and posturing of the hand and multimodal vibratory stimulation i.e. frequency, amplitude, duration ultrasound, vibration and applied forces.

A plurality of vibratory motors provides the capability to selectively and simultaneously input multiple frequency and amplitude vibratory stimulus to the fingers and palm of the hand. The linkage mechanism provides the capability to provide high and low frequency movement or kinesthetic stimulus to the fingers and palm.

The embodiments of this technology will provide the capability to emulate multiple geometries with varied stiffnesses. Environmental sensors directly and/or wirelessly connected to the device can send data to the handheld device which can be communicated to the user via vibration and movement of the fingers. In one embodiment information from a lidar sensor on the handle can be communicated to the user to communicate object detection, distance measurements and spatial data to a user. A magnetic field or hall effect sensor attached to the device could communicate north, south, east, west to a user with visual impairment Information from biometric sensors such as heart rate, breathing, blood sugar sensors (on the user or a separate individual or group) directly and/or wirelessly connected to the apparatus can be communicated to the user.

In one embodiment force sensitive resistors are embedded within the flexible enclosure at selected regions of minimal deflection and stretching to provide measures of forces applied by the hand to the apparatus.

In one embodiment an adjustable strap attached to two sections of the hand grip, and spans the back of the hand, adjacent to the metacarpophalangeal joints and the distal transverse arch of the hand. See FIG. 11C. The strap supports stable and connection to the hand of a user.

In one embodiment the thumb yoke spans the distal and proximal phalanges. This thumb yoke integrates a small joystick which can be used to control a cursor, mouse of key stroke sequences in computerized devices. The joystick can also be used to measure movements of the thumb during usage of the device.

The device can be connected via wifi and may be compatible with Bluetooth or other capable connections to be used with exergames or rehabilitation games as a game controller.

A heart rate monitor in the strap can also provide information about user state analysis and estimation in controlled tasks performed with the apparatus.

A cover shape changing/morphing apparatus is comprised of a plurality of nodes and a plurality of links, including a plurality of bistable links, rigid panels, rigid links, and compliant links interconnected by a series of compliant and rigid hinges of multiple architectures. The linkages can be used as force transmitting members. This provides the capability to provide programmable amounts of resistive force in response to a force applied to the cover apparatus.

A cover shape changing/morphing apparatus is comprised of a plurality of bistable links, rigid panels, rigid links, and compliant links interconnected by a series of compliant and rigid hinges of multiple architectures. The linkages can be used as force transmitting members. This provides the capability to provide programmable amounts of resistive force in response to a force applied to the cover apparatus.

A cover shape changing/morphing apparatus is comprised of unit cell bistable elements connected to form an assembly that changes geometry from a single stable predetermined shape to minimum of one other stable predetermined shape.

A shape changing apparatus, wherein transition between a first stable position and a second stable position is accomplished by applying an outward or inward radial forces and displacement on pluralities of links.

A plurality of vibration motor actuators can be programmed to induce sequences of vibration at select input locations, corresponding to positions of the linkages and geometry of the cover apparatus to cue grasping postures, coordinated movement of the hand and manipulation strategies.

A cover apparatus which integrates a plurality of unit cell compliant bistable element, and particular arrangements thereof, that can transform or morph a structure from one shape to another.

An apparatus is comprised of a plurality of multiple pitch lead screws with clockwise/right-handed and counter clockwise left-handed threaded sections, slider crank mechanisms that produce displacement and apply forces to a user's hand.

An apparatus comprised of a plurality of multiple pitch lead screws with clockwise/right-handed and counter clockwise left-handed threaded sections, slider crank mechanisms and vibration motors that can be dynamically apply multiple sequences of displacements and forces.

An apparatus that can produce computer programmable thumb adduction and abduction, and finger flexion and extension.

The combination of computer-controlled movement of the elements connected to the fingers and thumb in conjunction with the use of vibration motors can be used to convey localized normal and shear cutaneous forces to phalanges of the fingers to stimulate the sensor neurons in the palm and mimic the sensation of intermediate joint positions—and thereby intermediate geometries.

The complete apparatus has the capability to produce kinesthetic-haptic illusions to alter perception of size and geometry of segments of the apparatus and/or perception of objects manipulated via teleoperation or within virtual environments.

An apparatus that functions as both an input to register hand posture and grasp forces and output. When grasped, the apparatus can be actuated to provide force feedback to the hand to generate a sensation of grasping firm to soft objects. Information can be communicated as representations of letters, numbers, and symbols through mechanical cues provided by a plurality of integrated (magnus and clavicula) keys, vibration motors, ultrasound speakers, and thumb abb/adduction sub-assemblies.

A device and method for electronically mediated training and therapeutic movement. The plurality of sensors and smart control of the motors can be utilized diagnostically to determine tremors and more specifically tremor characteristics in the hand and fingers in resting state and during task performance. This can be used in analyses and diagnoses of symptoms and progression of diseases such as stroke and Parkinson's diseases.

Computer control can be used for targeted therapeutic intervention through induced movement and posturing of the hand and multimodal vibratory stimulation i.e. frequency, amplitude, duration of ultrasound, vibration and applied forces.

A connection via wifi, Bluetooth or the like to enable exergames or rehabilitation games as a game controller. The device wherein the control system comprises computer controls, human controls or a gaming platform.

Although the disclosed device and method have been described with reference to disclosed embodiments, numerous modifications and variations can be made and still the result will come within the scope of the disclosure. No limitation with respect to the specific embodiments disclosed herein is intended or should be inferred.

### REFERENCES

1. Ojeda-Alonso J, Calvo-Enrique L, Paricio-Montesinos R, Kumar R, Zhang M D, Poulet J F A, Ernfors P, Lewin G R. Sensory Schwann cells set perceptual thresholds for touch and selectively regulate mechanical nociception. Nat Commun. 2024 Feb. 6; 15(1):898. doi:10.1038/s41467-024-44845-8. PMID: 38320986; PMCID: PMC 10847425.
2. [Hoetmer, Karin, Herder, Just L and Kim, Charles. “A Building Block Approach for the Design of Statically Balanced Compliant Mechanisms”. International Design Engineering Technical Conference San Diego, Calif., USA, 2009. Vols. DETC 2009 87451].
3. Abraira V E, Ginty D D. The sensory neurons of touch. Neuron. 2013 Aug. 21; 79(4):618-39

I claim:

1. A device for electronically-mediated therapy and training, the device comprising:
a central drive mechanism having a sliding joint for moving a user's finger away from the palm;
an interface having a flexible surface and one or more actuation sensing components such as buttons or sensors, each of the buttons and sensors connected to a linkage sub-assembly, the interface thereby forming a controller to enable precise finger manipulation by a user of the core drive mechanism to provide both input and output to the user; the linkage sub-assembly capable of creating alterations in the contours of the interface and having a control component to control adjustments to the linkages of the subassembly; and
the interface comprising one or more compliant bistable elements attached to the central drive mechanism that can selectively vary position of elements and an overall shape of the interface device.

2. The device of claim 2 further comprising one or more motors to rotate the central drive mechanism to motivate the device from a stable cylindrical 3D geometry to a spherical geometry with finger placement along the interface

3. The device of claim 2, wherein a change of geometries changes a power or cylindrical grip of the user to a spherical grip posture.

4. The device of claim 1 further comprising a four-bar mechanism sub-assembly adapted to provide movement radially and on the long axis of the interface, the four-bar mechanism sub-assembly having a lateral linkage, a medial linkage with an elongated slot, a magnus key, a modified lead screw nut and a modified lead screw nut linkage.

5. The device of claim 1 further comprising computer controls to induce movement and posturing of the user's hand, said computer controls comprising multimodal vibratory stimulation i.e. frequency, amplitude, duration ultrasound, vibration and applied forces.

6. The device of claim 1 further comprising accelerometers to detect an orientation of the device relative to each of the user's fingers and palm.

7. A device for electronically-mediated therapy and training, the device comprising:
a central drive mechanism having a sliding joint for moving a user's finger away from the palm;
an interface having a flexible surface and one or more actuation sensing components such as buttons or sensors, each of the buttons and sensors connected to a linkage sub-assembly, the interface thereby forming a controller to enable precise finger manipulation by a user of the core drive mechanism to provide both input and output to the user; the linkage sub-assembly capable of creating alterations in the contours of the interface and having a control component to control adjustments to the linkages of the subassembly; and
the interface comprising three bi-stable latching sub-assembly to securely connect to the user's thumb, the index and middle fingers, the ring and small fingers to the device and hold the thumb and fingers to maintain contact with the interface.

8. The device of claim 7 further comprising a thumb adduction and abduction subassembly having a lead screw mechanism and slider crank mechanism, the adduction/abduction subassembly utilizing two ball joint couplings and a sliding joint to move the thumb along trajectories away from the palm, thereby allowing the user to apply forces parallel to the palm along the side of the fingers in an adducted position and to apply forces to oppose the finger tips in abducted position.

9. The device of claim 7 further comprising computer controls to induce movement and posturing of the user's hand, said computer controls comprising multimodal vibratory stimulation i.e. frequency, amplitude, duration ultrasound, vibration and applied forces.

10. The device of claim 7 further comprising accelerometers to detect an orientation of the device relative to each of the user's fingers and palm.
